(19) United States
(12) Patent Application Publication
(10) Pub. No.: US 2005/0278417 A1
(43) Pub. Date: Dec. 15, 2005

(54) Client access to web services

(75) Inventors: Paul Z. Fremantle, Emsworth (GB); Simon A.J. Holdsworth, Andover (GB); Christopher E. Sharp, Winchester (GB)

Correspondence Address: Edward H. Duffield;IBM Corp, IP Law Dept T81/503, 3039 Cornwallis Road, PO Box 12195, Research Triangle Park, NC, 27709-2195, US

(73) Assignee: International Business Machines Corporation, Armonk, NY (US)

(21) Appl. No.: 10/402,185

(22) Filed: Mar. 26, 2003

(30) Foreign Application Priority Data
Dec. 21, 2002 (GB) 0229890.9

(51) Int. Cl. G06F 15/16

(52) U.S. Cl. 709/203

(57) ABSTRACT

The present invention provides a method, apparatus and computer program product which enables a web service gateway or web service server to provide a document, such as a WSDL, describing a target service to a requesting client which contains details which have been tailored for that client. For example, for a target service which provides access at different qualities of service, a WSDL can be returned in response to a client request, the WSDL containing details of how to access the target service at an appropriate quality of service for a user id which was specified with the client request.

### FIELD OF THE INVENTION

The present invention relates to the provision of web services and more particularly to tailoring client access to such services.

### BACKGROUND TO THE INVENTION

Over recent years it has become commonplace for a business to provide a web site on the Internet which, for example, enables a web client to purchase goods from the business over the world wide web. Following on from this success it has more recently become a requirement to handle more complex e-business applications on the Internet which, for example, enable business to business communication and this requirement has been satisfied by the arrival of Web services. Web services are modular and enhanced e-business applications that enable programmatic interaction between applications across the Internet. Based on shared, open, and emerging technology standards and protocols, such as SOAP (Simple Object Access Protocol), UDDI (Universal Description, Discovery and Integration), and WSDL (Web Service Definition Language), Web services can communicate, interact, and integrate with heterogeneous applications, irrespective of their implementation formats. Web services can interact with one another across the Internet to facilitate dynamic integration between businesses, suppliers, partners, and customers.

For example, a web service which provides an e-business application publishes its URL in a well known UDDI directory. A client can then obtain the URL from the UDDI directory and contact the e-business using the URL in order to obtain a WSDL document. The WSDL describes the interface provided for clients by the service e-business application, one or more transport mechanisms, for example SOAP over HTTP, (HyperText Transport Protocol) and an end point address for each transport mechanism. Once a client has the WSDL it can invoke the interface via the specified end point using the specified transport mechanism. Further if the client has an e-business application with which the service e-business application may wish to communicate the client and service may exchange WSDL documents in order to make this possible.

Further in this environment it may be advantageous for a target service to provide, for example, different levels of service to different clients such that select clients are provided with access to a high performance target service with rich functionality, while other clients are provided with access to a lower performance target service with reduced functionality.

### SUMMARY OF THE INVENTION

The present invention provides a method, apparatus and computer program product which enables a client to be provided with tailored access to a target service.

According to a first aspect the present invention provides a method for a data processing host to provide access to a target service, the method comprising: receiving a request from a client for a document describing the target service, the request including client identity information; using the client identity information to modify an initial document describing the target service to produce a modified document which contains a description of the target service, wherein the description is tailored for the client; and returning the modified document in response to the client request; thereby enabling the data processing host to provide access to the target service which is tailored for the client.

According to a second aspect the invention provides an apparatus for providing access to a target service, the apparatus comprising: means for receiving a request from a client for a document describing the target service, the request including client identity information; means for using the client identity information to modify an initial document describing the target service to produce a modified document which contains a description of the target service, wherein the description is tailored for the client; and means for returning the modified document in response to the client request; thereby enabling the apparatus to provide access to the target service which is tailored for the client.

Preferably a database comprising profile data associated with client identity information is used to obtain information relating to the description of the target service which is tailored for the client. The database may be held in non-volatile memory such as a database or volatile memory such as RAM. For example, if the client identity information is a user id, the database will contain details relating to user ids. For example, the database may include details which specify for a plurality of user ids whether or not each user id should be given a document describing the target service which enables high priority access to a target service.

The data processing host could be, for example, a web services server in which target service resides. Alternatively, for example, it could be a web services gateway via which the client accesses the target service.

Optionally the target service provides support for at least one operation and the description of the target service which is tailored for the client identity specify any target service operations which the client can access. For example some clients are given a document describing the target service which enables access to a rich set of operations whilst other clients are given a document describing the target service which enables access to a reduced set of operations.

Optionally the modified document includes details which enable the client to access the target service at a predetermined quality of service. For example some clients are given a document describing the target service which enables access through a high priority channel whilst other clients are given a document describing the target service which enables access through a lower priority channel.

Optionally the modified document includes details of information to be specified by the client when accessing the target service. For example, based on client identity information of a user id and password a client is given a document describing the target service which includes a string which indicates that the client has been authenticated and which the client must use when accessing the target service. Alternatively, for example, the string specifies that client operation requests should be given high priority by the target service. Note that such information can be passed as part of a context associated with a client operation request, alternatively it can be specified as a parameter of the operation to which the operation request is directed.

Optionally the modified document contains two or more of: the target service operations which the client can access; details to enable the client to access the target service at a predetermined quality of service; and details of information to be specified by the client when accessing the target service.

Preferably the client identity information comprises a user id and password. Alternatively, for example, it could be just a user id. Alternatively it could represent a client type, for example, whether or not the user is an administrator, user or guest. For example whether or not the client is secure or non-secure. Optionally the client identity information is passed as part of a context associated with the client request for a document describing the target service.

Optionally the document could be, for example, in XML, but is preferably in WSDL.

According to a third aspect the present invention provides a computer program product comprising a computer usable medium having computer readable program code means embodied therein for causing a data processing apparatus to provide access to a target service, the computer readable program code means in said computer program product comprising computer readable program code means for causing a computer to effect the functions of the second aspect.

According to a fourth aspect the present invention provides an article of manufacture comprising a computer usable medium having computer readable program code means embodied therein for causing a data processing apparatus to provide access to a target service, the computer readable program code means in said article of manufacture comprising computer readable program code means for causing a computer to effect the steps of the first aspect.

According to a fifth aspect the present invention provides a program storage device readable by machine, tangibly embodying a program of instructions executable by the machine to perform method steps for a data processing apparatus to provide access to a target service, said method steps comprising the steps of the first aspect.

### BRIEF DESCRIPTION OF THE DRAWINGS

The invention will now be described, by way of example only, with reference to a preferred embodiment thereof, as illustrated in the accompanying drawings, in which:

FIG. 1 is a schematic diagram of a data processing environment in which the preferred embodiment of the present invention can be advantageously applied;

FIG. 2 is a schematic diagram of a client accessing a target service according to the prior art;

FIG. 3 is a schematic diagram of a client obtaining access to a target service according to the preferred embodiment of the present invention; and

FIG. 4 is a schematic diagram of a client obtaining access accessing a target service via a gateway according to an alternative embodiment of the present invention;

Note that in the figures like numbers are used to denote like parts.

### DESCRIPTION OF THE PREFERRED EMBODIMENT

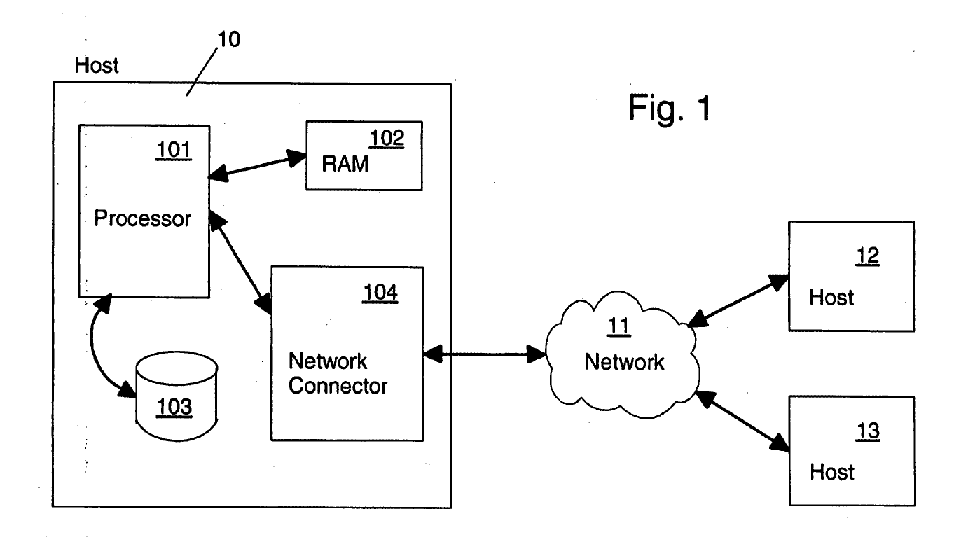

FIG. 1 is a block diagram of a data processing environment in which the preferred embodiment of the present invention can be advantageously applied; In FIG. 1, a client/server data processing host 10 is connected to client/server data processing hosts 12 and 13 via a network 11, which could be, for example, the Internet. For example a client program could be executing on host 10 which is accessing a target service on host 12 via a gateway server on host 13. Client/server 10 has a processor 101 for executing programs that control the operation of the client/server 10, a RAM volatile memory element 102, a non-volatile memory 103, and a network connector 104 for use in interfacing with the network 11 for communication with the other client/servers 12 and 13.

In the embodiments which follow the document describing target service is a WSDL document. Note that a WSDL document contains details of the target service such as Port Type, Bindings, Ports, Messages, Types etc. The Port Type defines the operations and associated parameters provided by the target service, the Bindings specify the transport mechanisms, and the Port specifies the end point addresses for channels providing access to the target service using the transport mechanisms. For the purposes of the preferred embodiment only the Port Type, transport mechanism specified in the Bindings, and end point address specified in the Port are considered.

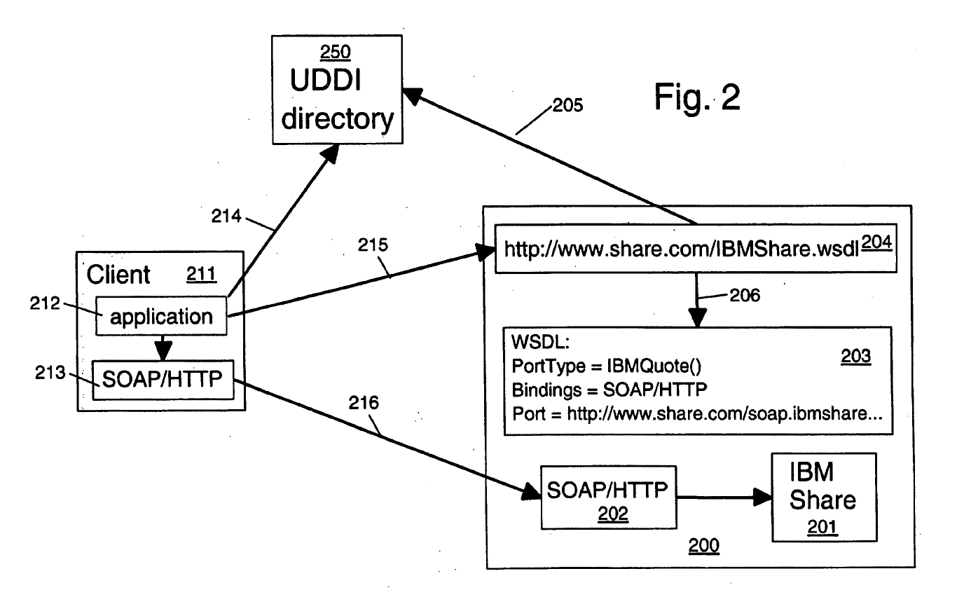

FIG. 2 is a schematic diagram showing an example of a client accessing a target service according to the prior art. The figure shows an IBM Share service (201) which is available at a target server (200). The target server has a channel (202) which supports communication using a transport mechanism of SOAP over HTTP. The IBM Share service is described in a WSDL document (203) which specifies a Port Type of Quote( ), binding for the channel which specifies a transport mechanism of SOAP/HTTP and a Port which specifies an end point address of

http://www.share.com/soap.ibmshare. The server registers (205) the IBM Share service with a known UDDI directory (250) by providing the type of the service, for example “IBMShare”, and the URL

(http://www.share.com/ibmshare.wsdl) of a servlet (204) from which a client can obtain a copy of the WSDL. The UDDI directory may be known to the target, for example, through configuration information.

A client process (211) is running an application (212) which wishes to access the IBM Share service. The client process includes a channel (213) which provides a transport mechanism of SOAP over HTTP. The application first accesses (214) the UDDI directory (250) to obtain details of an IBM Share service and in return receives details of the URL (http://www.share.com/IBMShare.wsdl) of the servlet (204) from which the IBM Share service WSDL can be obtained. The client application then requests (215) the WSDL document (203) from the servlet (204) which the servlet returns. Based on this document the application requests (216) the Quote( ) operation of the IBM Share service as specified in the Port Type of the WSDL document using a transport mechanism of SOAP/HTTP as specified in the bindings of the WSDL document, and directing the request to the end point address specified in the Port of the WSDL document. The request (216) is received by the SOAP/HTTP channel (202) in the target server (200) and passed (206) to the IBM Share service (201).

However, the provider of the IBM Share service may wish to tailor access to the service based on, for example, a client user id and password. For example it may wish to make the Quoute( ) operation available to all clients and further Buy(n) and Sell(n) operations available to only selected trusted clients for whom a user id and password has been issued.

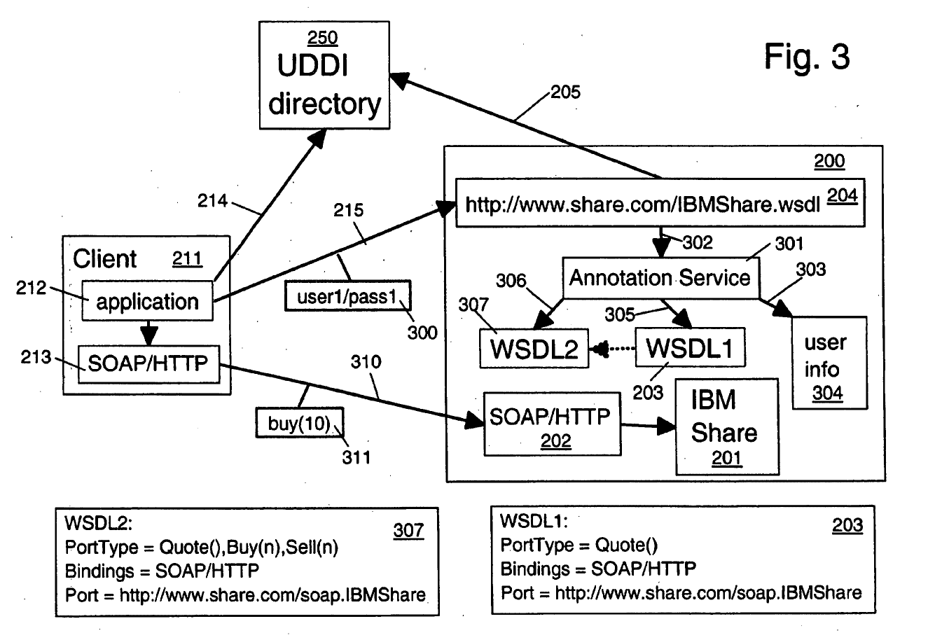

FIG. 3 is a schematic diagram of the data processing host (200) of FIG. 2 providing tailored access to the IBM Share service (201) based on a client id and password, according to the preferred embodiment of the present invention. The flow up to when the client application (212) requests (215) the IBM Share WSDL from the servlet (204) are the same as for FIG. 2, however in FIG. 3, the request (215) further includes a user id and password of “user1/pass1” (300) as part of a context associated with the request. This information is added to the context by software running in the client process, for example an implementation of WSIF (Web Services Invocation Framework), which supports the client application. When the servlet (204) receives the request it invokes (302) an annotation service (301) and passes to it the user id and password received with the request and the WSDL document requested, which in this case is WSDL1 (203). WSDL1 contains the details of the Quote( ), Buy(n) and Sell(n) operations provided by the IBM Share service, although Buy(n) and Sell(n) should only be made available to trusted clients. The annotation service then looks up (303) details of the user id and password in a user profile information database (304) which is held in volatile memory, to see if they are recognised and valid and, if so, discover which operations the client should be provided with access to. In this example the user id “user1” is recognised, but not as a trusted user, and the password “pass1” is valid. From this the client only has access to the Quote( ) operation and not the Buy(n) and Sell(n) operations and as a result the annotation service (301) accesses (305) WSDL1 (203) and removes from it details of the Buy(n) and Sell(n) operations thereby creating (306) WSDL2 (307). WSDL2 is then returned to the client application (212). As a result the application is able to send a request (310) to the target service but only for the Quote( ) operation (311) to discover the current price of IBM shares. Note that if the user id and password were valid and the user was a trusted user, WSDL1 (203) would be returned to the client application thereby providing access to the Quote( ), Buy(n) and Sell(n) operations.

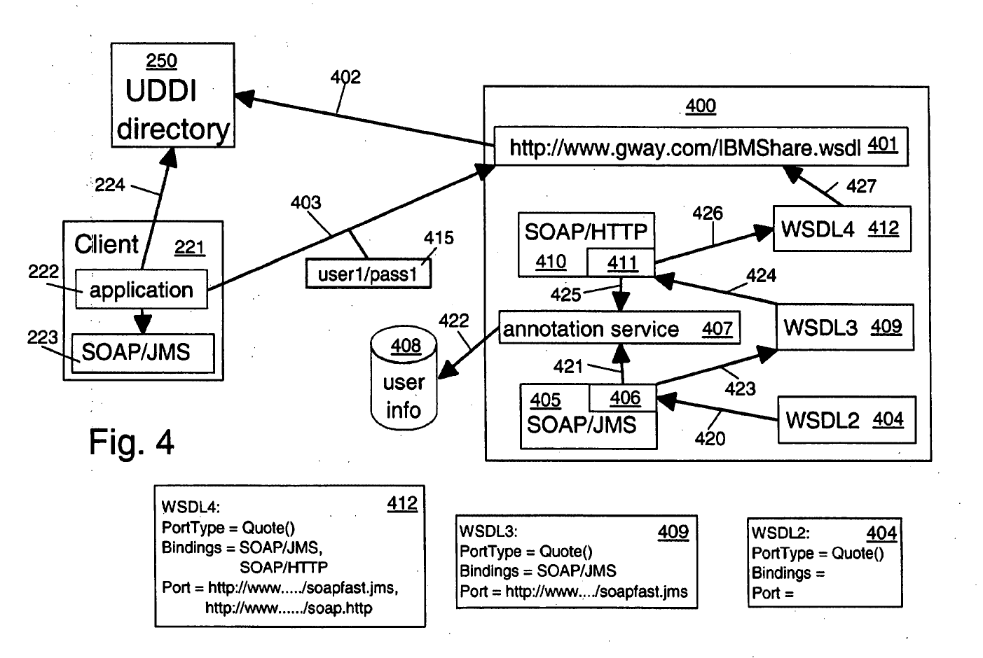

FIG. 4 is a schematic diagram of an alternative embodiment of the present invention in which a client obtains access to the IBM Share service (not shown in FIG. 4) via a web services gateway (400). The gateway was provided with a WSDL describing the IBM share service (such as WSDL1 (203 of FIG. 2) from which it removed the Binding and Port Information to produce WSDL2 (404). The gateway then registers (402) the IBM Shares service with a known UDDI directory (250) by providing the type of the service and the URL (http://www.gway.com/IBMShare.wsdl) of a servlet (401) from which a client can obtain a copy of the WSDL. The UDDI directory may be known to the gateway, for example, through configuration information.

A client process (221) is running an application (222) which wishes to access the IBM Share service. The client process includes a channel (223) which provides a transport mechanism of SOAP over JMS. The application first accesses (224) the UDDI directory (250) to obtain details of an IBM Share service and in return receives details of the URL (http://www.gway.com/IBMShare.wsdl) of the servlet (401) in the gateway (400) from which the IBM Share service WSDL can be obtained. The client application then requests (403) a WSDL document describing the IBM Share service from the servlet (401) and passes with the request a user id and password of “user1/pass1” (415). As a result of this request WSDL2 (404) and the user id and password are provided (420) to the SOAP/JMS channel (405) in the gateway server. The channel includes extra logic (406) for modifying a provided WSDL to add a binding which specifies the transport mechanism provided by the channel and a port which specifies an end point address for the channel. In order to do this the extra logic (406) calls (421) an annotation service (407) to verify the user id and password and obtain details relating to the channel for the user id. The annotation service then looks up (422) details of the user id and password in a user profile info database (408) which is held in non-volatile memory, to see if they are recognised and valid and, if so, discover any special information relating to the user for the channel. In this example the user id “user1” is recognised as a user with access to a special SOAP/JMS channel which provides high priority access to the IBM Share service, and “pass1” is valid. This information is returned to the SOAP/JMS channel extra logic (406) which adds Bindings of “SOAP/JMS” and a Port of “http://www.gway.com/soapfast.jms, the end point address of the SOAP/JMS channel which provides high priority access to the IBM Share service, to WSDL2 (404) in order to produce (423) WSDL3 (409). WSDL3 is then provided (424) to the SOAP/HTTP channel (410) which also includes extra logic (411). This extra logic also calls (425) the annotation service (407) which recognises that the user id and password have been validated for this request and finds nothing specific to the user relating to the SOAP/HTTP channel (410) on the user info database (408). As a result the extra logic (411) adds a default binding which specifies the transport mechanism provided by the channel, and a default port which specifies an end point address for this channel, to WSDL3 thereby producing (426) WSDL4 (412). WSDL4 is then returned to the client application (222) which can now access the IBM share service via a high priority SOAP/JMS channel. Note that if the user id and password were invalid or not specified the SOAP/JMS extra logic (406) would have added a Port of “http://www.gway.com/soap.jms, the end point address of a SOAP/JMS channel which provides normal priority access to the IBM Share service, to WSDL2 (404) in order to produce (423) WSDL3 (409.).

Note that in another embodiment it may be recognised from the user profile by the gateway (400) that the client (221) does not include a SOAP/HTTP channel and so the SOAP/HTTP channel extra logic (411) is either not called to add details of the channel to the WSDL or is called but does not add details of the channel to the WSDL. Further the user id and password included with the request could be checked by the gateway using with the annotation service (407) prior to providing the WSDL to the channels (405, 410) for modification.

Thus two embodiments have been described in which a target server and a web services gateway, as a result of a client request, tailor a generalised WSDL to produce a tailored WSDL to be returned to the client. The tailoring is based on a user id and password received with the client request, although this could equally be based on other client specific information such as client type, for example, guest/user/administrator. The information with the request is used to access profile data for the user/client type and accordingly tailor the generalised version of the WSDL. In the embodiments the WSDL is tailored to provide access to different operations and different qualities of service (high/normal priority) to users, although in both embodiments these could be combined. However these are just examples and other tailoring services are possible, for example a secure string could be added to the WSDL returned to the client which is then used in all client requests to the target service in order to provide authenticated access to the target service.

Thus the embodiments enable a web service gateway or web service server to provide a document, such as a WSDL, describing a target service to a requesting client which contains details which have been tailored for that client. For example, for a target service which provides access at different qualities of service, a WSDL can be returned in response to a client request, the WSDL containing details of how to access the target service at an appropriate quality of service for a user id which was specified with the client request.

Note that examples of FIGS. 2, 3 and 4 consider a simple target service which is a Share service with at most three operations. This is for illustrative purposes only and in practice the target services are likely to be more complex. Further note that the embodiments are described in terms of the target service providing a description of its interface and bindings in a WSDL document. However in practice this could be achieved in any document format which can be read and understood by a client and could, for example be XML. Further the WSDL document is made available via a UDDI directory. However in practice this could be via any source known to both the target service and client and which enables an appropriate exchange of information. It could, for example, be a Naming or Directory service.

Variations described for the present invention can be realized in any combination desirable for each particular application. Thus particular limitations, and/or embodiment enhancements described herein, which may have particular advantages to the particular application need not be used for all applications. Also, not all limitations need be implemented in methods, systems and/or apparatus including one or more concepts of the present invention.

The present invention can be realized in hardware, software, or a combination of hardware and software. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a a function described above. The computer readable program code means in the computer program product comprising computer readable program code means for causing a computer to effect one or more functions of this invention. Furthermore; the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

1. A method for a data processing host to provide access to a target service, the method comprising:
receiving a request from a client for a document describing the target service, the request including client identity information;
using the client identity information to modify an initial document describing the target service to produce a modified document which contains a description of the target service, wherein the description is tailored for the client; and
returning the modified document in response to the client request;
thereby enabling the data processing host to provide access to the target service which is tailored for the client.

2. The method of claim 1 wherein the step of using the client identity information comprises the further step of:
obtaining profile information from profile data associated with the client identity information and using the profile information to produce the modified document.

3. The method of claim 1 wherein the data processing host is a web services gateway via which the client accesses the target service.

4. The method of claim 1 wherein the target service provides at least one operation and the description of the target service in the modified document specifies any target service operations which the client can access.

5. The method of claim 1 wherein the modified document includes details which enable the client to access the target service at a predetermined quality of service.

6. The method of claim 1 wherein the modified document includes detail of information to be specified by the client when accessing the target service.

7. The method of claim 1 wherein the client identity information comprises a user id and password.

8. An apparatus for providing access to a target service, the apparatus comprising:
means for receiving a request from a client for a document describing the target service, the request including client identity information;
means for using the client identity information to modify an initial document describing the target service to produce a modified document which contains a description of the target service, wherein the description is tailored for the client; and
means for returning the modified document in response to the client request;
thereby enabling the apparatus to provide access to the target service which is tailored for the client.

9. The apparatus of claim 8 wherein the means for using the client identity information further comprises:
means for obtaining profile information from profile data associated with the client identity information and using the profile information to produce the modified document.

10. The method of claim 8 wherein the data processing host is a web services gateway via which the client accesses the target service.

11. The method of claim 8 wherein the target service provides at least one operation and the description of the target service in the modified document specifies the target service operations which the client can access.

12. The method of claim 8 wherein the modified document includes details which enable the client to access the target service at a predetermined duality of service.

13. The method of claim 8 wherein the modified document includes detail of information to be specified by the client when accessing the target service.

14. The method of claim 8 wherein the client identity information comprises a user id and password.

15. A computer program product comprising a computer usable medium having computer readable program code means embodied therein for causing a data processing apparatus to provide access to a target service, the computer readable program code means in said computer program product comprising computer readable program code means for causing a computer to effect the functions of claim 10.

16. An article of manufacture comprising a computer usable medium having computer readable program code means embodied therein for causing a data processing apparatus to provide access to a target service, the computer readable program code means in said article of manufacture comprising computer readable program code means for causing a computer to effect the steps of claim 1.

17. A program storage device readable by machine, tangibly embodying a program of instructions executable by the machine to perform method steps for a data processing apparatus to provide access to a target service, said method steps comprising the steps of claim 1.
